(19) United States
(12) Patent Application Publication
(10) Pub. No.: US 2011/0079549 A1
(43) Pub. Date: Apr. 7, 2011

(54) DEVICE AND FILTER CARTRIDGE FOR FILTERING LIQUID STATE MEDIUM

(76) Inventor: Lars Meijer, Nykvarn (SE)

(21) Appl. No.: 12/995,506

(22) PCT Filed: Apr. 30, 2009
(86) PCT No.: PCT/SE09/50473

§ 371 Date: Dec. 17, 2010

(30) Foreign Application Priority Data
Jun. 2, 2008 (SE) 0801287-4

(51) Int. Cl. B01D 35/00; F01M 11/03; B01D 27/00

(52) U.S. Cl. 210/248; 210/483; 210/167.02

(57) ABSTRACT

Device for filtration of liquid medium, having a filter housing (2) with a filtration chamber (3) delineated by a base element (10) and a cover (20). A drain duct (15) in the base element to drain medium from the filtration chamber. A filter cassette (30) fitted detachably in the filtration chamber. The filter cassette has a first endwall (31) towards the cover, a second endwall (32) towards the base element, and a filter element (33) fastened to, and extending between, the endwalls. The endwalls and the filter element together delineate an internal space (34) for a medium to be filtered. The filter cassette has a drain tube (40) which protrudes from the second endwall and has its inner end leading into the internal space of the filter cassette. The drain tube is accommodated in the drain duct when the filter cassette is fitted in the filtration chamber.

### FIELD OF THE INVENTION AND STATE OF THE ART

The present invention relates to a device for filtration of liquid medium according to the preamble of claim 1, and a filter cassette according to the preamble of claim 7. The invention relates also to a motor vehicle component comprising a filtration device according to the invention.

DE 196 06 616 A1 refers to a device according to the preamble of claim 1 for filtration of liquid medium, e.g. in the form of lubricating oil. That known device comprises an interchangeable filter cassette which can be fitted detachably in a filter housing between a base element and a cover of the filter housing. The filter housing is provided with a drain duct, the inlet aperture to which is covered by part of the cover when the cover is firmly screwed to the base element. When the cover is unscrewed from the base element, the inlet aperture of the drain duct is freed and it is possible for oil to flow out from the filter housing via the drain duct, thereby preventing a large amount of oil from remaining within the filter housing when the cover is removed from the base element of the filter housing. Spillage of oil to the environment during filter cassette changing is thereby reduced. A disadvantage of the solution described in DE 196 06 616 A1, however, is that the drain oil which flows through the drain duct comprises oil which has not passed through the filter element of the cassette and is therefore unfiltered. Particles accompanying this unfiltered drain oil may cause problems, e.g. in the form of increased wear and tear, if the drain oil is returned to the components which are intended to be lubricated and/or cooled by the oil.

### OBJECT OF THE INVENTION

The object of the present invention is to provide a solution to the problem indicated above of unfiltered drain medium in the case of a device provided with a filter cassette arranged in a filter housing.

### SUMMARY OF THE INVENTION

According to the present invention, said object is achieved by means of a device having the features defined in claim 1.

The device according to the invention comprises a filter housing and a filter cassette which can be fitted detachably in a filtration chamber delineated by a base element and a cover of the filter housing. The filter cassette is provided with a drain tube which protrudes from an endwall of the cassette facing towards the base element and which has its inner end leading into the internal space of the cassette. This drain tube is adapted to being accommodated in a drain duct of the base element of the filter housing when the cassette is fitted in the filtration chamber of the filter housing. The medium which flows into the drain duct before the cassette has been removed from the base element of the filter housing will thus be medium which has first passed through the filter element of the cassette into the internal space of the cassette, which means that this drain medium is filtered.

According to an embodiment of the invention, the drain tube is provided with an external seal means, preferably in the form of a O-ring, the drain tube being adapted to abutting sealingly against an inner wall of the drain duct via this seal means when the cassette is fitted in the filtration chamber. This is a simple and reliable way of ensuring that unfiltered medium is not allowed to flow into the drain duct from the region in the filtration chamber outside the cassette so long as the cassette remains in place in the filter housing.

According to another embodiment of the invention, the filter cassette is adapted to being fitted horizontally in the filtration chamber and the filtration chamber has a bottom surface which, as seen when looking from the base element towards the cover, slopes upwards relative to the horizontal plane. By suitable adaptation of this slope it is possible to ensure that the medium which does not reach up to the inlet of the drain duct and therefore remains in the filter housing when the cassette is removed from the filter housing is prevented from running out from the filter housing.

Other advantageous features of the device according to the invention are indicated by the dependent claims and the description set out below.

The invention relates also to a filter cassette having the features defined in claim 7 and a motor vehicle component having the features defined in claim 11.

Other advantageous features of the filter cassette according to the invention and the motor vehicle component according to the invention are indicated by the dependent claims and the description set out below.

### BRIEF DESCRIPTION OF THE DRAWINGS

The invention is described in more detail below on the basis of embodiment examples with reference to the attached drawings, in which:

FIG. 1 depicts a schematic longitudinal sectional view of a device according to a first embodiment of the present invention,

FIG. 2 depicts a schematic cross-sectional view of a filter cassette forming part of the device according to FIG. 1, and

FIG. 3 depicts a schematic longitudinal sectional view of a portion of a device according to a second embodiment of the invention.

### DETAILED DESCRIPTION OF PREFERRED EMBODIMENTS

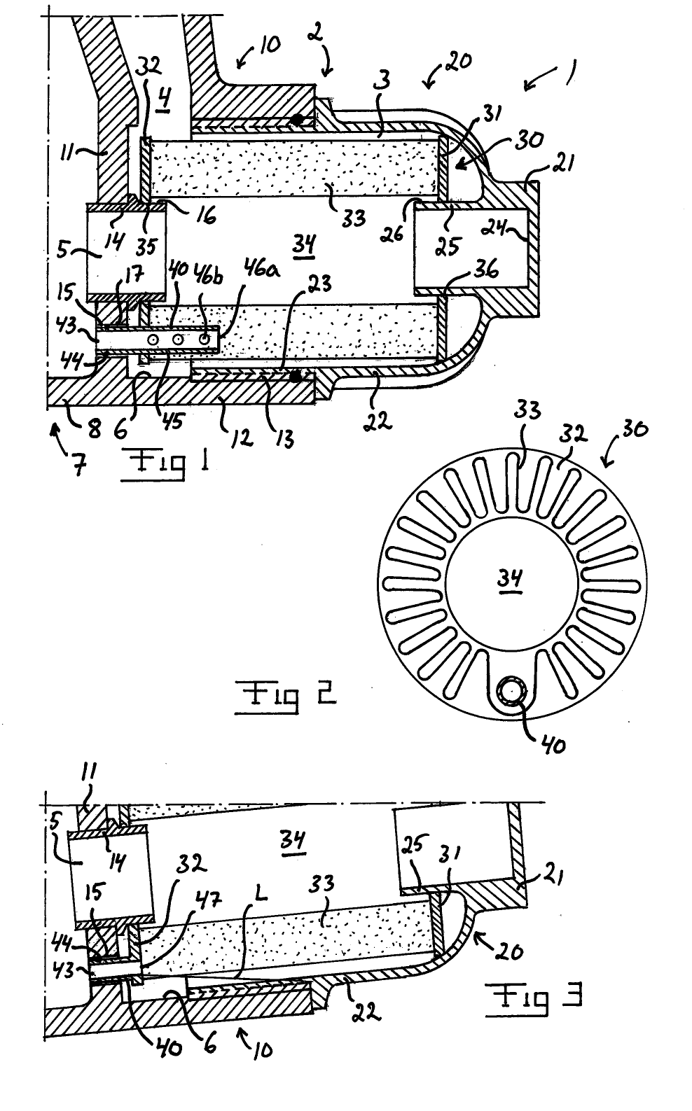

FIG. 1 illustrates a device 1 according to the present invention for filtration of liquid medium, e.g. in the form of oil or liquid fuel. The device comprises a filter housing 2 with a base element 10 and a cover 20 which is fastened detachably to the base element. The base element 10 and the cover 20 together delineate a filtration chamber 3 when the cover 20 is fastened to the base element 10. This filtration chamber 3 is intended to receive medium which needs filtering.

The base element 10 comprises a rear wall 11 which constitutes a first end surface of the filtration chamber 3. The base element 10 further comprises a cylindrical wall 12 which protrudes from the rear wall 11 towards the cover 20. At its inner end the cylindrical wall 12 connects to the rear wall 11 and at its outer end the cylindrical wall 12 is provided with an internal thread 13.

The cover 20 comprises an end portion 21 which constitutes a second end surface of the filtration chamber 3. The cover 20 further comprises a cylindrical wall 22 which protrudes from the end portion 21 towards the base element 10. At its end further from the base element 10, the cylindrical wall 22 of the cover connects to the end portion 21 of the cover, and at its end nearer to the base element the cylindrical wall 22 of the cover is provided with an external thread 23 intended to cooperate with the internal thread 13 of the cylindrical wall 12 of the base element in order to lock the cover 20 firmly to the base element 10. The cover 20 can thus be firmly screwed to the base element 10 via said mutually cooperating threads 13, 23.

An inlet 4 for feeding medium into the filtration chamber 3 and an outlet 5 for feeding medium out from the filtration chamber 3 are provided in the base element 10. In the example illustrated, the inlet 4 is arranged close to the cylindrical wall 12 of the base element, while the outlet 5 is arranged in the rear wall 11 of the base element. The outlet 5 comprises a sleeve 14 which protrudes from the rear wall 11 of the base element and extends into the filtration chamber 3 and which is fastened to and abuts sealingly against the rear wall 11. A drain duct 15 for drainage of medium from the filtration chamber 3 is provided in the rear wall 11 of the base element.

The device 1 further comprises an interchangeable filter cassette 30 which can be fitted detachably in the filtration chamber 3 by clamping between the base element 10 and the cover 20. This filter cassette 30 takes the form of a so-called insert filter and is intended to be taken out as necessary from the filter housing 2 for cleaning and subsequent refitting in the filter housing or for replacement by a new filter cassette. The filter cassette 30 comprises a first endwall 31 intended to face towards the cover 20, and a second endwall 32 arranged at a distance from the first endwall 31 and intended to face towards the base element 10. The filter cassette 30 further comprises a filter element 33 fastened to, and arranged to extend between, the endwalls 31, 32. The endwalls 31, 32 and the filter element 33 together delineate an internal space 34 of the filter cassette for receiving filtered medium. Medium received in the filtration chamber 3 is intended to flow via the filter element 33 into the internal space 34 of the filter cassette from the space in the filtration chamber outside the filter cassette 30, whereby the filter element 33 filters the medium and intercepts pollutant particles accompanying the medium. The filtered medium is thereafter intended to flow out from the filter cassette 30 through an outlet aperture 35 arranged in the second endwall 32. The outlet aperture 35 is close to the outlet 5 of the filter housing 2 when the filter cassette 30 is fitted in the filtration chamber 3. The second endwall 32 is arranged to abut sealingly against the external surface 16 of the sleeve 14 when the filter cassette 30 is fitted in the filtration chamber 3 so that unfiltered medium from the region in the filtration chamber outside the filter cassette is prevented from passing out through the outlet 5.

In the embodiments illustrated, the cover 20 has a sleeve 25 which protrudes from the bottom 24 of the cover towards the base element 10 and which is adapted to extending through an aperture 36 in the first endwall 31 of the filter cassette 30 when the filter cassette 30 is fitted in the filtration chamber 3. The first endwall 31 is adapted to abutting sealingly against the external surface 26 of the sleeve when the filter cassette 30 is fitted in the filtration chamber 3 so that unfiltered medium from the region in the filtration chamber outside the cassette is prevented from passing into the internal space 34 of the cassette via the aperture 36 in the first endwall 31.

In the embodiments illustrated, the filter cassette 30 is cylindrical with the filter element 33 extending a complete turn round the filter cassette, and the respective endwalls 31, 32 have the shape of a circular disc with a central hole. The filter element 33 is with advantage folded with fold lines extending between the endwalls 31, 32 in the longitudinal direction of the filter cassette.

The filter cassette 30 is provided with a drain tube 40 which protrudes from the second endwall 32 towards the base element 10 of the filter housing and which has its inner end leading into the internal space 34 of the filter cassette, i.e. within the filter element 33. At its outer end, the drain tube 40 has an outlet aperture 43. The drain tube 40 is adapted to being accommodated in the drain duct 15 when the filter cassette 30 is fitted in the filtration chamber 3. The drain tube 40 is configured to abut sealingly against the inner wall 17 of the drain duct 15 when the filter cassette 30 is fitted in the filtration chamber 3 so that unfiltered medium from the region in the filtration chamber outside the cassette is prevented from passing out through the drain duct 15 so long as the filter cassette is connected to the base element 10. In the embodiments illustrated, the drain tube 40 is provided with an external seal means 44 in the form of an O-ring and abuts sealingly against the inner wall 17 of the drain duct 15 via this seal means 44 when the filter cassette 30 is fitted in the filtration chamber 3.

In cases where the filter cassette 30 is intended to be fitted horizontally in the filtration chamber 3, the drain tube 40 has to be arranged as close to the periphery of the second endwall as possible, and the drain duct 15 as close to the bottom surface 6 of the filtration chamber as possible.

In the embodiment illustrated in FIGS. 1 and 2, the drain tube 40 extends into the internal space 34 of the filter cassette, and the portion 45 of the drain tube which extends into the internal space 34 of the filter cassette has one or more inlet apertures 46a, 46b via which medium is allowed to flow into the drain tube 40 from said internal space 34. In this case, the drain tube 40 has with advantage an axial inlet aperture 46a arranged in an open inner end of the drain tube, and one or more radial inlet apertures 46b arranged in the wall of the drain tube.

In the embodiment illustrated in FIG. 3, the drain tube 40 has in the second endwall 32 an inlet aperture 47 via which medium is allowed to flow into the drain tube 40 from the internal space 34 of the filter cassette. In this case, there is therefore no portion of the drain tube 40 which extends into the internal space 34 of the filter cassette.

The drain tube 40 may take the form of an independently manufactured component which is fastened, e.g. by adhesive bonding, to the endwall 32 of the cassette, as illustrated in FIG. 1. Alternatively, the drain tube 40 and the endwall 32 may be integral, as illustrated in FIG. 3.

In cases where the filter cassette 30 is adapted to being fitted horizontally in the filtration chamber 3, the filtration chamber has with advantage a bottom surface 6 which, as seen when looking from the base element 10 towards the cover 20, slopes upwards relative to the horizontal plane, e.g. at an angle of about 5 degrees, as illustrated in FIG. 3.

When the filter cassette 30 is to be taken away from the filter housing 2, e.g. for cleaning or replacement, the infeed of medium to the filtration chamber 3 via the inlet 4 is first discontinued. Filtered medium will thereafter flow out from the filtration chamber 3 via the internal space 34 of the filter cassette, the outlet 5 and the drain tube 40 until only a small volume of medium remains at the bottom of the filtration chamber 3. The upper surface of this remaining medium is represented in FIG. 3 by the line L. After the medium has been allowed to drop to its lower level in the filtration chamber 3, the cover 20 is unscrewed from the base element 10 and the filter cassette 30 is released from the base element 10.

The filter element 33 takes with advantage the form of a filter cloth which may be a fabric made of, for example, glass fibre or cellulose. The drain tube 40 and the endwalls 31, 32 of the cassette are with advantage made of plastic material.

The device 1 according to the invention forms with advantage part of a motor vehicle component 7 which has a casing 8 to accommodate lubricating and/or cooling oil, the filter housing 2 being arranged close to said casing 8 to receive oil from the latter. Oil from the casing 8 is fed into the filtration chamber 3 via the inlet 4 and is thereafter caused to pass through the filter element 33 of the filter cassette 30 in order thereby to be filtered, after which the filtered oil is returned to the casing 8 via the outlet 5 of the filtration chamber. The drain duct 15 is connected to the casing 8 in order to return drained oil to the casing 8. The motor vehicle component 7 may for example be a rear axle, a gearbox, a combustion engine, a retarder etc.

The device according to the invention is particularly intended to be used in a heavy motor vehicle, e.g. a bus, a tractor unit or a truck.

The invention is of course in no way limited to the embodiments described above, since a multitude of possibilities for modifications thereof are likely to be obvious to a specialist in the field without thereby having to deviate from the basic concept of the invention as defined in the attached claims.

1. A device for filtration of liquid medium, the device comprising:
a filter housing comprising:
a base element,
a cover fastened detachably to the base element,
a filtration chamber, delineated by the base element and the cover, for receiving medium to be filtered,
an inlet for feeding medium into the filtration chamber,
an outlet for feeding medium out from the filtration chamber, and
a drain duct arranged in the base element for draining of medium from the filtration chamber;
an interchangeable filter cassette detachably fitted in the filtration chamber and which comprises:
a first endwall facing towards the cover,
a second endwall opposing and spaced at a distance from the first endwall and facing towards the base element,
a filter element extending between the endwalls and configured for filtration of the medium,
an internal space, delineated by the endwalls and the filter element, for receiving the filtered medium, and
an outlet aperture in the second endwall, positioned and configured for feeding filtered medium out from the internal space of the filter cassette to the outlet of the filter housing,
a drain tube from the filter cassette and protruding from the second endwall, the drain tube having an inner end leading into the internal space of the filter cassette, the drain tube being accommodated in the drain duct of the base element of the filter housing when the filter cassette is fitted in the filtration chamber.

2. A device according to claim 1, wherein the drain tube has a portion that extends into the internal space of the filter cassette, and the drain tube portion has one or more inlet apertures configured to allow medium to flow into the drain tube from the internal space.

3. A device according to claim 1, wherein the drain tube has an inlet aperture in the second endwall via which medium is allowed to flow into the drain tube from the internal space of the filter cassette.

4. A device according to claim 1, wherein the drain tube is configured to abut sealingly against an inner wall of the drain duct when the filter cassette is fitted in the filtration chamber.

5. A device according to claim 4, wherein the drain tube has an external seal configured to abut sealingly against an inner wall of the drain duct via the seal when the filter cassette is fitted in the filtration chamber.

6. A device according to claim 1, wherein the filter cassette is configured to fit in a horizontal orientation in the filtration chamber and the filtration chamber has a bottom surface which slopes upwards relative to a horizontal plane from the base element towards the cover.

7. A filter cassette configured for detachably fitting in a filtration chamber of a filter housing, the filter cassette comprising:
a first endwall,
a second endwall opposing and spaced at a distance from the first endwall,
a filter element fastened to, and extending between, the endwalls and configured for filtration of liquid medium,
the endwalls and the filter element delineating an internal space for receiving the filtered medium, and
an outlet aperture in the second endwall positioned and configured for feeding filtered medium out from the internal space,
a drain tube from the filter cassette and protruding from the second endwall and the drain tube having an inner end leading into the internal space.

8. A filter cassette according to claim 7, wherein the drain tube has a portion that extends into the internal space of the filter cassette, and the drain tube portion has one or more inlet apertures configured to allow medium to flow into the drain tube from the internal space.

9. A filter cassette according to claim 7, wherein the drain tube has an inlet aperture in the second endwall and medium is allowed to flow into the drain tube through the inlet aperture from said internal space of the filter cassette.

10. A filter cassette according to claim 7, further comprising an external seal on the drain tube.

11. A motor vehicle component comprising a casing for accommodating lubricating and/or cooling oil, the motor vehicle component including a device according to claim 1 for filtration of oil accommodated in the casing.

12. A device according to claim 5, wherein the seal comprises an O-ring around the drain tube.
